(19) United States
(12) Patent Application Publication
(10) Pub. No.: US 2026/0350930 A1
(43) Pub. Date: Nov. 5, 2026

(54) Augmenting a Live Video Image Stream with Visual Effects

(71) Applicant: Apple Inc., Cupertino, CA (US)

(72) Inventors: Christopher M. Garrido, Santa Clara, CA (US); Hjalte Wedel Vildhoej, Sunnyvale, CA (US); Johnny Trenh, Milpitas, CA (US); Shuang Gao, San Jose, CA (US); Kevin A. Robertson, Sunnyvale, CA (US)

(21) Appl. No.: 19/488,033

(22) PCT Filed: May 31, 2024
(86) PCT No.: PCT/US2024/032111

§ 371 Date: Nov. 25, 2025

Related U.S. Application Data
(60) Provisional application No. 63/506,002, filed on Jun. 2, 2023.

(51) Int. Cl. G06T 19/00; G06T 3/40; G06T 7/194; G06T 7/50; G06T 15/50

(52) U.S. Cl. CPC G06T 19/006; G06T 3/40; G06T 7/194; G06T 7/50; G06T 15/50; G06T 2207/10016; G06T 2207/20132; G06T 2207/30201; G06T 2219/024

(57) ABSTRACT

Devices, methods, and non-transitory program storage devices are disclosed for augmenting live video image streams with visual effects that are composited directly into the video image stream. For example, a first electronic device may obtain a video image stream. Then, for each of one or more images in the video stream, the electronic device may: perform a segmentation operation on the image to identify foreground and background portions of the image; assign a first depth value for the foreground portion of the image (and, optionally, a second depth value to the background portion); augment the image with at least a first visual effect, wherein the first visual effect is assigned a third depth value; and then composite a rendering of at least: (a) the foreground portion of the image at the first depth value and (b) the first visual effect at the third depth value into an augmented output image.

### TECHNICAL FIELD

This disclosure relates generally to the field of audio and video data streaming. More particularly, but not by way of limitation, it relates to techniques for augmenting live video image streams with various visual effects, e.g., depth-aware visual effects that are composited directly into the video image stream.

### BACKGROUND

The advent of portable integrated computing devices has caused a wide proliferation of cameras and other video capture-capable devices. These integrated computing devices commonly take the form of smartphones, tablets, or laptop computers, and typically include general purpose computers, cameras, sophisticated user interfaces including touch-sensitive screens, and wireless communications abilities through Wi-Fi, Bluetooth, LTE, HSDPA, New Radio (NR), and other cellular-based or wireless technologies. The wide proliferation of these integrated devices provides opportunities to use the devices' capabilities to perform tasks that would otherwise require dedicated hardware and software.

For example, portable integrated computing devices, such as smartphones, tablets, and laptops typically have two or more embedded cameras. These cameras generally amount to lens/camera hardware modules that may be controlled through the use of a general-purpose computer using firmware and/or software (e.g., applications, or “apps”) and a user interface, including touch-screen buttons, fixed buttons, and/or touchless controls, such as voice control. The integration of high-quality cameras into these portable integrated communication devices, such as smartphones, tablets, and laptop computers, has enabled users to capture and share images and videos in ways never before possible. It is now common for users' smartphones to be their primary image capture device of choice.

Along with the rise in popularity of photo and video sharing via portable integrated computing devices having integrated cameras has come a rise in videoconferencing (and other audiovisual (AV) content sharing sessions) via such portable integrated computing devices. In particular, users often engage in videoconferencing calls or meetings where they share video images and/or other graphical content, with the video images typically being captured by a front-facing camera on the device, i.e., a camera that faces in the same direction as the camera device's display screen. Most prior art cameras are optimized for either wide-angle, general photography or for narrower-angle photography, e.g., self-portraits and videoconferencing streaming use cases. Those cameras that are optimized for wide angles are typically optimized for group and landscape compositions, but are not optimal for individual portraits, due, e.g., to the distortion that occurs when subjects are at short distances from the camera or at the edges of the camera's field of view.

Thus, in some cases, users may benefit from having greater flexibility in their choice of image capture sources to use in videoconferencing (or other AV content sharing) sessions and, in particular, the ability to leverage higher-quality image capture devices during such sessions (e.g., a camera that is integrated into a different device than the device that is hosting the session, such as one of their portable communication devices). Doing so may allow the users to stream higher-quality audio and/or video images to a second electronic device for subsequent presentation, storage, or further transmission by the second electronic device.

However, there remains an additional need for the ability to augment live video image streams in various ways, such as: augmentation with depth-aware visual effects that are composited directly into the video image stream; augmentation with real-time virtual lighting effects that are composited directly into the video image stream; improved resolution of visual content that is transmitted as part of the video image stream; and improved AV synchronization in augmented video image streams that contain video and/or audio content from multiple sources that are composited into a single live video image stream.

### SUMMARY

Devices, methods, and non-transitory program storage devices (NPSDs) are disclosed herein to enable the augmentation of live video image streams with various visual effects and/or other enhancements, e.g., visual effects and enhancements that may be composited directly into the video image stream, such that the augmented video image stream could be displayed at the device of the user that captured the live video image stream and/or transmitted to the device of another user for display.

For example, a first image processing method is disclosed herein, comprising: obtaining, at a first electronic device, a video image stream comprising a plurality of images of a scene captured by a first image capture device; and, then, for at least a first image of the video image stream: performing a segmentation operation on the first image to identify at least a foreground portion and a background portion of the first image; assigning a first depth value within the scene for the foreground portion of the first image; (optionally) assigning a second depth value within the scene for the background portion of the first image; augmenting the first image with at least a first visual effect, wherein the first visual effect is assigned a third depth value within the scene; compositing a rendering of at least: (a) the foreground portion of the first image at the first depth value and (b) the first visual effect at the third depth value into a first augmented output image; and transmitting the first augmented output image to a second electronic device. According to some embodiments, the method may further comprise augmenting the first image with at least a second visual effect, wherein the second visual effect is assigned a fourth depth value within the scene and composited at the fourth depth value into the first augmented output image, and wherein the third depth value and fourth depth value may be different from each other.

According to other embodiments, the first image of the video image stream may be visually enhanced in at least one of the following ways before being obtained at the first electronic device: being cropped according to one or more predetermined framing rules, having distortion corrected applied, or having tone mapping applied.

According to still other embodiments, the first image capture device may be connected to the first electronic device in one of the following ways: a wired connection, a wireless connection, or via being embedded in first electronic device.

According to some embodiments, the first augmented output image is transmitted to the second electronic device as part of a videoconferencing application. According to some such embodiments, the first visual effect may comprise a graphical window containing visual content, wherein the visual content is rendered into a first augmented output image, at least in part, at a second resolution that is independent of a first resolution at which the visual content is being displayed at the first electronic device.

According to other embodiments, the first depth value is assigned based on an estimated depth within the scene of the foreground portion of the first image.

According to still other embodiments, the third depth value is at least one of: (1) less than the first depth value; (2) greater than the first depth value; (3) between the first depth value and the second depth value; or (4) equal to the first depth value.

According to yet other embodiments, the first visual effect comprises at least one of: (1) a virtual lighting effect; (2) a graphical window containing visual content; or (3) a graphical representation of a reaction of a human subject captured in the scene.

According to further embodiments, the first visual effect comprises a graphical window containing visual content, and the third depth value is greater than the first depth value.

According to some embodiments, the foreground portion of the first image comprises at least one human subject. According to some such embodiments, the first visual effect comprises a graphical window containing visual content, wherein the foreground portion is cropped based on a size and location of a detected face of the human subject prior to rendering. According to other such embodiments, the first visual effect comprises a graphical representation of a reaction of the human subject, wherein at least one of: (1) the third depth value; or (2) a placement of the graphical representation of the reaction of the human subject is based, at least in part, on a size or location of the human subject. According to still other such embodiments, the first visual effect comprises a graphical representation of a reaction of the human subject, and the graphical representation comprises an emoji or an image. According to yet other such embodiments, the first visual effect may comprise a virtual lighting effect, wherein the virtual lighting effect comprises at least one of: (1) a virtual light color; (2) a virtual light intensity; or (3) a virtual light placement, and wherein augmenting the first image with the virtual lighting effect further comprises estimating a set of surface normals for the human subject in the first image.

According to other embodiments, the first visual effect comprises a graphical window containing visual content, and wherein the visual content of the graphical window is selected via an application programming interface (API) or operating system (OS)-level feature of the first electronic device.

According to still other embodiments, the first visual effect comprises a graphical window containing first audiovisual (AV) content, wherein the video image stream comprises second AV content, and wherein a timing of an audio component of the first AV content is adjusted based, at least in part, on a timing of an audio component of the second AV content before being transmitted to the second electronic device. In some implementations, the timing of the audio component of the first AV content may specifically be adjusted based, at least in part, on a moving average difference between (1) the timing of the audio component of the first AV content and (2) the timing of the audio component of the second AV content.

Various non-transitory program storage device embodiments are also disclosed herein. Such NPSDs are readable by one or more processors. Instructions may be stored on the NPSDs for causing the one or more processors to perform any of the embodiments disclosed herein. Various electronic devices are also disclosed herein, e.g., comprising memory, one or more processors, image capture devices, displays and/or other electronic components, and programmed to perform in accordance with the various method and NPSD embodiments disclosed herein.

### BRIEF DESCRIPTION OF THE DRAWINGS

FIG. 1 illustrates exemplary electronic device configurations for establishing a secure connection between the electronic devices for streaming audio and/or video image data, according to one or more embodiments.

FIG. 2 illustrates various examples of live video image streams augmented with graphical windows containing visual content, according to one or more embodiments.

FIGS. 3A-3B illustrate exemplary visual effects that may be applied to augment live video streams, according to one or more embodiments.

FIG. 4 illustrates an exemplary visual effect configured to improve the resolution of visual content transmitted as part of a live video stream, according to one or more embodiments.

FIG. 5 illustrates exemplary virtual lighting effects that may be applied to augment live video streams, according to one or more embodiments.

FIGS. 6A-6B illustrate exemplary techniques for performing improved audiovisual (AV) synchronization in augmented live video streams, according to one or more embodiments.

FIG. 7 is a flow chart illustrating a method of augmenting a live video image stream with depth-aware visual effects, according to various embodiments, according to various embodiments.

FIG. 8 is a block diagram illustrating a programmable electronic computing device, in which one or more of the techniques disclosed herein may be implemented.

### DETAILED DESCRIPTION

In the following description, for purposes of explanation, numerous specific details are set forth in order to provide a thorough understanding of the inventions disclosed herein. It will be apparent, however, to one skilled in the art that the inventions may be practiced without these specific details. In other instances, structure and devices are shown in block diagram form in order to avoid obscuring the inventions. References to numbers without subscripts or suffixes are understood to reference all instance of subscripts and suffixes corresponding to the referenced number. Moreover, the language used in this disclosure has been principally selected for readability and instructional purposes and may not have been selected to delineate or circumscribe the inventive subject matter, and, thus, resort to the claims may be necessary to determine such inventive subject matter. Reference in the specification to “one embodiment” or to “an embodiment” (or similar) means that a particular feature, structure, or characteristic described in connection with the embodiments is included in at least one embodiment of one of the inventions, and multiple references to “one embodiment” or “an embodiment” should not be understood as necessarily all referring to the same embodiment.

The techniques disclosed herein relate generally to augmenting a live video image stream (e.g., as part of a videoconferencing session) with certain visual effects (e.g., adding graphical overlays, performing certain image processing effects related to virtual lighting and/or camera angles, extracting portions of a human subject's body from a video stream and compositing the extracted portions with other graphical content for the outgoing augmented live video image stream, etc.), as well as improving the resolution and/or AV synchronization of composited AV content that is transmitted as part of the augmented live video image stream.

In some cases, the video image augmentation can involve segmenting particular objects (or classes of objects, such as foreground and background objects) from the video images into multiple layers, assembling the multiple layers of the original video image according to a desired composition technique or visual effect (e.g., by manipulating the virtual depth of one or more of such layers in the z-axial direction of the scene), applying the desired augmentation to one or more of the layers, and then compositing the various layers into an augmented video image before transmission, such that a standard video image stream may be transmitted to another device, e.g., via a network.

### Exemplary Device Setups for Establishing Secure Audiovisual (AV) Connections Between Electronic Devices

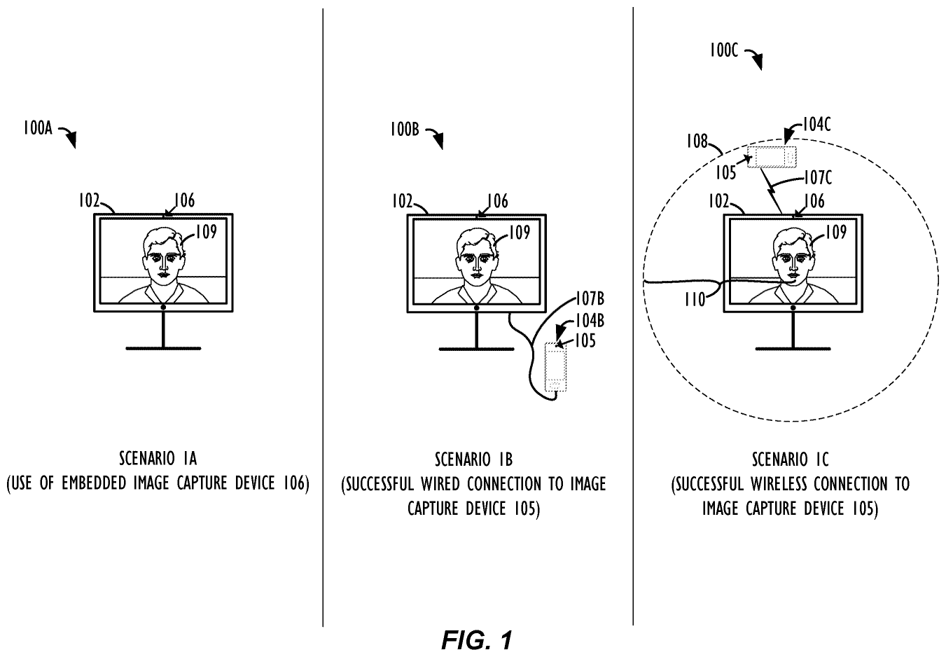

Turning now to FIG. 1, exemplary electronic device configurations 100 for establishing secure connections between the electronic devices for streaming audio and/or video image data are shown, according to one or more embodiments.

Turning first to a simplified Scenario 1A (100A), a first device 102 comprises an embedded image capture device 106 (e.g., a “webcam,” or the like), which may be connected internally to the other components of first device 102 and may be used to capture one or more exemplary images (109) of the scene surrounding first device 102, e.g., including one or more human subjects.

Turning next to Scenario 1B (100B), the first device 102 again comprises an embedded image capture device 106, but also has formed a secure wired connection, e.g., via wired connection 107B, with a second device (104B), which itself has an embedded image capture device 105 (and may have one or more additional embedded image capture devices, as well).

In some cases, an image capture device 105 of the second device may be of a higher quality than the image capture device(s) 106 of the first device, e.g., in terms of resolution, zoom, field of view (FOV), spatial resolution, focus, color quality, or any other imaging parameter. In such cases, it may be more desirable to use the image capture device 105 of the second device rather than the image capture device 106 of the first device to capture images to be used, augmented, displayed, stored, transmitted, etc., by the first device (102), e.g., as part of an active AV communication session.

In still other cases, a user of the first device 102 may simply desire to select an image capture device of the second device 104B for any number of other reasons, e.g., to provide a different (and/or additional) view of the scene around the first device 102, because the first device 102 may not have an image capture device of its own, because an image capture device of the first device 102 is not functioning properly, because an image capture device of the second device 104B may have a special image capture feature or mode desired by the user of the second device (e.g., a “Portrait” or synthetic shallow depth of Field (SDOF) photography mode, a “Night” capture mode, a “Slow Motion” video capture mode, etc.), and so forth.

Turning now to Scenario 1C (100C), the first device 102 and a second device 104C are in proximity to one another and attempting to form a secure wireless connection, e.g., wireless connection 107C, over an agreed-upon wireless connection protocol. As used herein, the term “in proximity to” may refer to devices that are within a discoverability distance of each other for a given wireless connection protocol, e.g., as illustrated by boundary circle 108, having a radius 110. According to some implementations, measured signal strength may be used as a proxy for estimating the distance between two devices to determine if they are within a sufficiently close range of one another. In some such implementations, the threshold signal strength required for determining that two devices are within sufficiently close proximity to one another may not be a fixed threshold, and it also may be based on filtering (e.g., averaging) signal strength values over time across many signal strength samples. In some embodiments, first device 102 may comprise one or more image capture devices (e.g., 106), and second device 104C may also comprise one or more image capture devices (e.g., 105).

In some embodiments, after successful connection, second device 104C could appear seamlessly alongside any other image capture sources available for selection at the first device 102, e.g., alongside image capture devices that internal to (i.e., embedded in) first device 102 (such as image capture device 106), image capture devices connected directly to first device 102 (e.g., via a USB port, such as is shown in the example of Scenario 1B), and so forth.

### Exemplary Live Video Image Streams Augmented with Graphical Windows Containing Visual Content

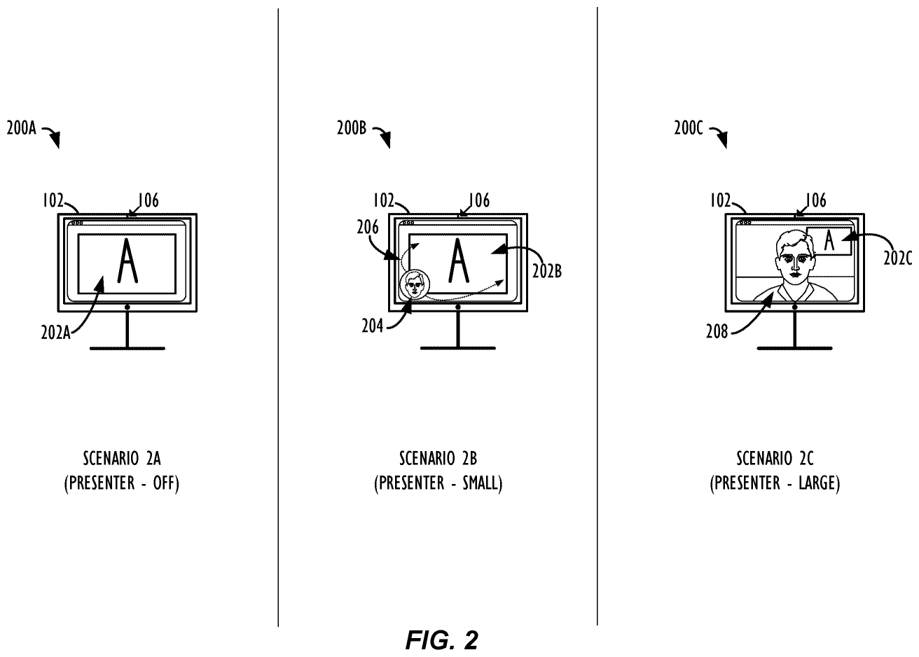

Turning now to FIG. 2, various examples of live video image streams being augmented with graphical windows containing visual content are illustrated, according to one or more embodiments. It is noted that the three scenarios 200A-200C provide an illustration of the view that a receiving party of a videoconferencing or other AV content session would see, according to some implementations. In other words, the human subject illustrated in Scenario 2B (200B) and Scenario 2C (200C) of FIG. 2, also referred to in this example as a “Presenter,” would be the sending party, located at a different physical place than first device 102, and the graphical content 202A-202C would reflect the visual content that is being transmitted by said sending party to the receiving party. In some cases, the sending party may experience a similar view to the receiving party on the display of their electronic device, a different view than the receiving party, and/or a “preview” window showing a preview of the live video image stream that is being sent to the receiving party.

Beginning with Scenario 2A (200A), a so-called “Presenter—OFF” mode is illustrated, wherein the receiving party receives a view of only a graphical window 202A having visual content (in the case, the capital letter ‘A’ represents the visual content transmitted within the graphical window). In Scenario 2A, no visual representation of the “Presenter” (e.g., the sending party) is transmitted to the receiving party. In some implementations of Scenario 2A, however, one or more synchronized audio streams may be transmitted to the receiving party, along with graphical window 202A (e.g., one audio stream may be obtained from an active microphone at the Presenter's sending device, and another audio stream may be associated with the visual content being displayed in graphical window 202A).

Next, turning to Scenario 2B (200B), a so-called “Presenter—SMALL” mode is illustrated, wherein the receiving party receives a view of graphical window 202B having visual content, as well as a visual representation of the Presenter (204). In some implementations of Scenario 2B, a foreground portion of the image captured by the sending device (e.g., including a human subject) may be further cropped, e.g., based on a size and location of a detected face of the human subject prior to being composited with the visual content of graphical window 202B and being rendered and transmitted to the receiving device. As shown in Scenario 2B (200B), a relatively small and tight crop around the head of Presenter 204 has been produced by the sending party. In this way, the visual content of graphical window 202B may remain the focus of the videoconferencing session, while still giving the recipient a view and connection to the Presenter as they are speaking. In some implementations, an image framing framework, implemented a set of one or more predetermined cropping rules, may be executing at the sending device, so as to keep the Presenter centered, zoomed to an appropriate level, distortion corrected, etc., so that the head of Presenter 204 (if that is what is desired in the given implementation) remains nicely framed in the composited image that is sent to the receiving party.

In some implementations, the sending party may be able to drag or otherwise move (e.g., see arrows 206) the small representation of Presenter 204 (e.g., of themselves) around the videoconferencing session window in real-time, so as to re-position and/or re-size the representation with respect to the visual content of graphical window 202B in a visually-pleasing way.

In some cases, the small representation of Presenter 204 may be rendered at the same depth as the visual content of graphical window 202B, regardless of Presenter 204's depth in the scene as captured. In other cases, the small representation of Presenter 204 may be rendered at a greater depth (or a lesser depth) than the visual content of graphical window 202B, depending on the preferences of a given use case. In still other implementations of Scenario 2B, the small representation of Presenter 204 may be bound to the graphical window 202B that the user is sharing.

In still other implementations of Scenario 2B, one or more synchronized audio streams may be transmitted to the receiving party, along with graphical window 202B (e.g., one audio stream may be obtained from an active microphone at the Presenter's sending device, and another audio stream may be associated with the visual content being displayed in graphical window 202B).

Finally, turning to Scenario 2C (200C), a so-called “Presenter—LARGE” mode is illustrated, wherein the receiving party receives a view of graphical window 202C having visual content, as well as a visual representation of the Presenter (208). In some implementations of Scenario 2C, a graphical window 202C containing visual content may be assigned a depth value and composited in front of (i.e., at a lesser depth), behind (i.e., at a greater depth), or at the same depth as a foreground portion of the image captured by the sending device (e.g., including a human subject).

As shown in Scenario 2C (200C), a relatively small view of graphical window 202C has been produced by the sending party's device and positioned behind or “over the shoulder” of the Presenter (208). In this way, the Presenter (208) may remain the focus of the videoconferencing session, while still giving the recipient a view and connection to the visual content of graphical window 202C as the Presenter (208) is speaking.

In some implementations, the sending party may be able to re-position and/or re-size the representation of graphical window 202C with respect to the Presenter (208) in a visually-pleasing way, i.e., before transmitting the composited and rendered video image stream to the receiving party.

In still other implementations of Scenario 2C, one or more synchronized audio streams may be transmitted to the receiving party, along with graphical window 202C (e.g., one audio stream may be obtained from an active microphone at the Presenter's sending device, and another audio stream may be associated with the visual content being displayed in graphical window 202C). It is to be understood that a Presenter may seamlessly transition between any of the Scenarios 2A, 2B, and 2C during the same live video image stream, as desired.

### Examples of Visual Effects That May Be Applied to Augment Live Video Streams

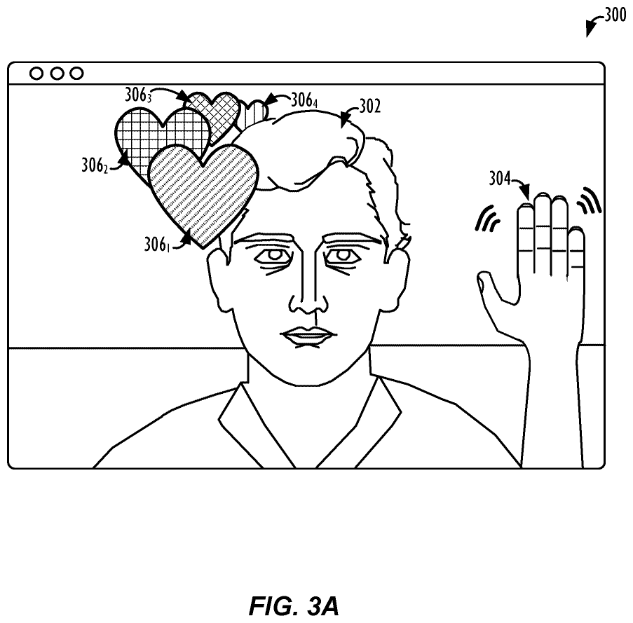

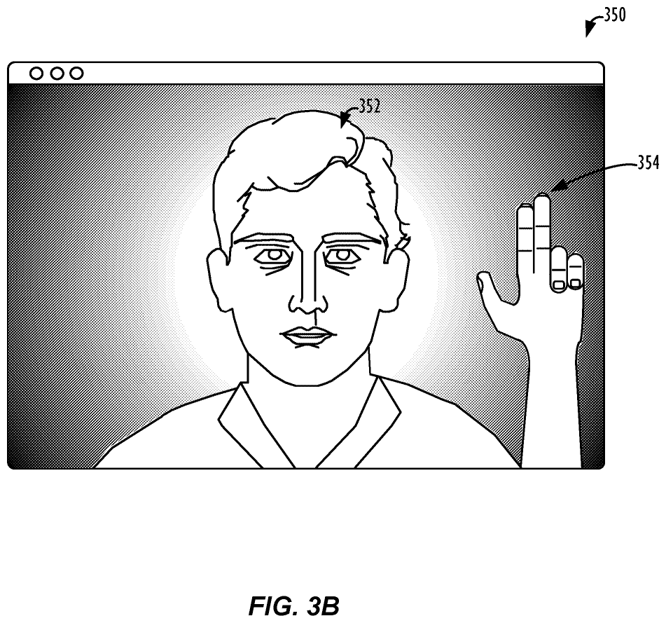

Turning now to FIG. 3A, an exemplary visual effect 300 that may be applied to augment live video streams is illustrated, according to one or more embodiments. Exemplary visual effect 300 involves the placement and compositing of one or more graphical elements (306) into a live video image stream. In some embodiments, graphical elements 306 may comprise depth-aware graphical representations (e.g., an emoji and/or an image or series of images). In other embodiments, the graphical representations may be representative of a reaction of a human subject (302) in the video image stream. In some cases, the reaction of the human subject 302 may be indicated by a facial expression, movement, gesture (e.g., handwaving gesture 304), spoken word command, or typed word command, etc., during the video image stream. In some cases, at least one of a depth value or a placement of a particular graphical element 306 may be based, at least in part, on a size or location of the human subject 302.

Returning to the particular example of FIG. 3A, exemplary handwaving gesture 304, when detected by one or more algorithms processing and interpreting the video images captured by the sending device in real time, causes a series of graphical emoji hearts (3061-3064) to be composited and rendered into an augmented version of the originally-captured video image. In this example, the first heart (3061) is placed in the image frame relative to a detected location of a head of human subject 302 in the foreground portion of the originally-captured video image, e.g., slightly overlapping and to the left of the detected head. Additionally, a depth value is assigned to the first heart (3061) that is less than a determined/estimated depth associated with the human subject in the foreground portion of the scene, such that the first heart (3061) is able to obscure the view of a portion of the head of the human subject 302. Additional graphical elements may be placed at the same depth as the head of the human subject 302 (e.g., 3062), at a greater depth than the head of the human subject 302 (e.g., 3063 and 3064), etc. It is to be understood that, the example illustrated in FIG. 3A is but one example of depth-aware visual effects that may be applied to augment a live video stream, according to the techniques described here.

Additionally, it is to be understood that the placement of the various graphical elements 306 within the video image may change over time, e.g., based on what the particular visual effect is attempting to convey. For example, the hearts 306 could spin around human subject 302's head for a fixed amount of time, could fade into the background of the scene a predetermined rate and eventually disappear, could change in size/color/transparency over time, etc. However, because the graphical elements may be both depth-aware and aware of the placement (and size) of human subjects in the foreground portion of the captured video image, highly-contextually relevant visual effects may be composited and rendered into the augmented live video image stream according to the techniques described herein.

Exemplary handwaving gesture 304 is but one example of a detected gesture that may trigger the initiation of a visual effect. In other embodiments, gestures may be detected that are right hand-specific, left hand-specific, multi-handed, involve particular uses of particular fingers, or particular sequences of movements, etc. Moreover, the size and/or placement of a given visual effect may be determined based, at least in part, on the type of visual effect that has been initiated. For example, as will be described below with reference to FIG. 3B, some visual effects may take up (and/or replace) the entire background portion of the captured video image. Other visual effects may be placed based on a current location of a human subject's hands, head, body, etc.

Turning now to FIG. 3B, another exemplary visual effect 350 that may be applied to augment live video streams is illustrated, according to one or more embodiments. As alluded to above, in the example of visual effect 350, an exemplary two-fingered gesture 354 made by human subject 352 (which may also, e.g., be required to be made with a particular hand of the user, within a particular distance of the user's head, within a particular depth range within the captured scene, etc.) initiates a visual effect that takes up (and replace) the entire background portion of the captured video image. In some implementations, visual effect 350 may play out over a predetermined number of captured video image frames or a predetermined amount of time. In some implementations, visual effect 350 may be based on the successful execution of a segmentation algorithm that identifies the background portion of each captured video image frame in real-time. In some implementations, visual effect 350 may also involve introducing an “artificial” shadow or other lighting/coloration change on the face or body of human subject 352, e.g., to provide a greater sense of realism to the receiving party that the visual effect is truly “interacting” with the human subject 352.

### Visual Effects Configured to Improve Resolution of Visual Content Transmitted as Part of a Live Video Stream

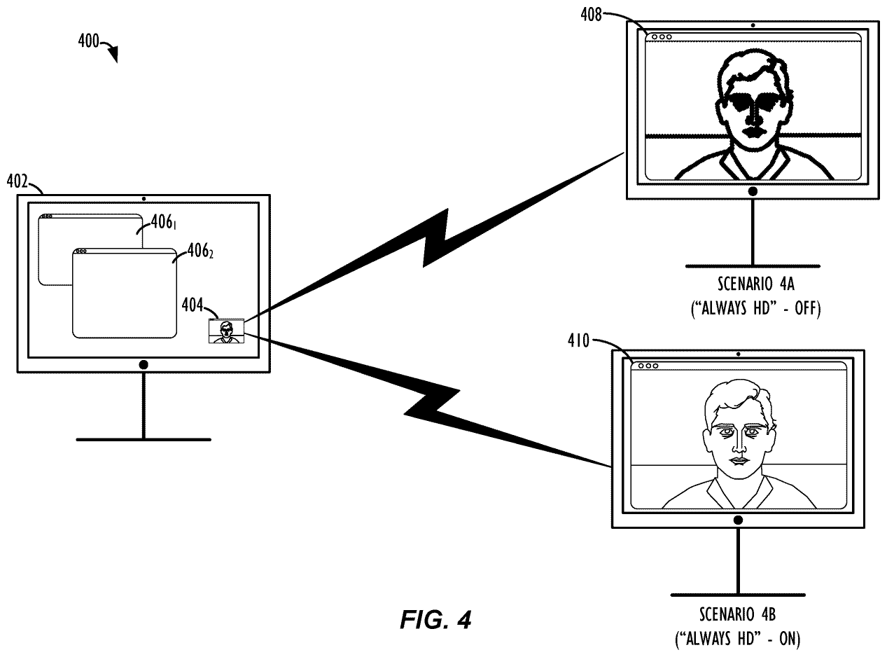

Turning now to FIG. 4, an exemplary visual effect 400 configured to improve the resolution of visual content transmitted as part of a live video stream is illustrated, according to one or more embodiments. As illustrated in FIG. 4, an exemplary sending electronic device 402 is transmitting a live video image stream (which may also comprise one or more streams of synchronized audio data) to exemplary receiving electronic devices 408 and 410.

The display of sending electronic device 402 may have a first display resolution, e.g., 1080p (i.e., 1,080 vertical rows of pixels), 4K (i.e., 2,160 vertical rows of pixels), 8K (i.e., 4,320 vertical rows of pixels), etc. The display of sending electronic device 402 may also be used to display one or more graphical windows containing visual (or AV) content, such as exemplary windows 404, 4061, and 4062 illustrated in FIG. 4. In the example illustrated in FIG. 4, a user has elected to share the content currently being displayed in window 404 with the receiving parties operating exemplary receiving electronic devices 408 and 410.

As illustrated, during the content sharing session, the sending user may be displaying window 404 with much smaller than a full screen resolution (e.g., in a 300×200 pixel-sized graphical window), e.g., due to overall screen size limitations on their device, the concurrent usage of other graphical windows (e.g., 406₁ and 406₂), or any number of other organizational or aesthetic reasons. In a naïve implementation, as illustrated in the top-half of FIG. 4 (labeled “Scenario 4A ‘Always HD’—OFF”), the visual content being displayed in window 404 that is being shared may be backed by a full display-sized buffer for device for 402 (e.g., a 1080p buffer, 4K buffer, 8K buffer, etc.), but because the window 404 being shared is so small locally on the sending user's device, it may end up being upscaled dramatically in order to fill the full display-sized buffer, resulting in blurry text and/or imagery if displayed at full-screen resolution at the receiving party's device, as shown on the display screen at exemplary receiving electronic device 408.

By contrast, in a novel implementation described herein that improves the resolution of visual content that is transmitted as part of a live video stream, the content being shared (e.g., window(s), screens, applications, etc.) by a sending party may be captured into a buffer before it has been scaled (e.g., downscaled) to whatever size the sending party is currently displaying it at. This buffer information may then be given as a pre-stage to the capturer application (e.g., the videoconferencing or AV content sharing application), and then it may be scaled down (if necessary) and put on the display screen of the sending party's device at the desired size. In this way, AV content that is captured before being downscaled—as well as all system fonts, system text, or any other graphical content that is programmatically-rendered or resolution-independent will be at its sharpest when received by the receiving party, as illustrated in the bottom-half of FIG. 4 and exemplary receiving electronic device 410 (labeled “Scenario 4B ‘Always HD’—ON”). In other words, using these resolution-preserving techniques, the AV content received by the receiving party as part of the AV sharing session will always have an “HD” (i.e., high-definition) look, i.e., independent of the resolution at which the visual content is currently being displayed at the sending electronic device. In some cases, the resolution of the visual content may be the same at the sending and receiving device; in other cases, the resolution may be greater at the receiving device (with the benefit of no loss in visual clarity, as described above); while, in still other cases, the resolution may actually be smaller at the receiving device (if so desired by the receiving party). In any event, the receiving party will no longer be constrained or limited by the resolution of the visual content as currently being displayed on the sending party's electronic device.

According to some embodiments, an accelerated experience may be provided to a sending/sharing party for selecting content and starting a content sharing session. In particular, according to such embodiments, the visual content/graphical window(s) that a party wishes to share may be conveniently selected via an application programming interface (API) or operating system (OS)-level feature of the sending electronic device. In other words, screen/content sharing features/menus of individual videoconferencing or other AV content sharing applications no longer have to utilized to initiate a content sharing session. Instead, the OS-level feature for the selection of content to be shared may be used which may, e.g., be built into every graphical window displayed within the OS, or within some other OS-level control panel, as desired by a given implementation. Once the sharing selection has been specified and confirmed by a user, the content may begin being shared to the receiving party in a seamless fashion. In some embodiments, additional graphical windows, applications, etc., may be added to the sharing session via the above-mentioned OS-level feature, without the need for tearing down the initial sharing session, utilizing the content sharing features of two different videoconferencing applications simultaneously, etc. In some embodiments, the OS-level feature may also provide the ability for a user to seamlessly “swap” out entire graphical windows, applications, displays, etc., that are being shared to a receiving party during a given content sharing session.

### Virtual Lighting Effects That May Be Applied to Augment Live Video Streams

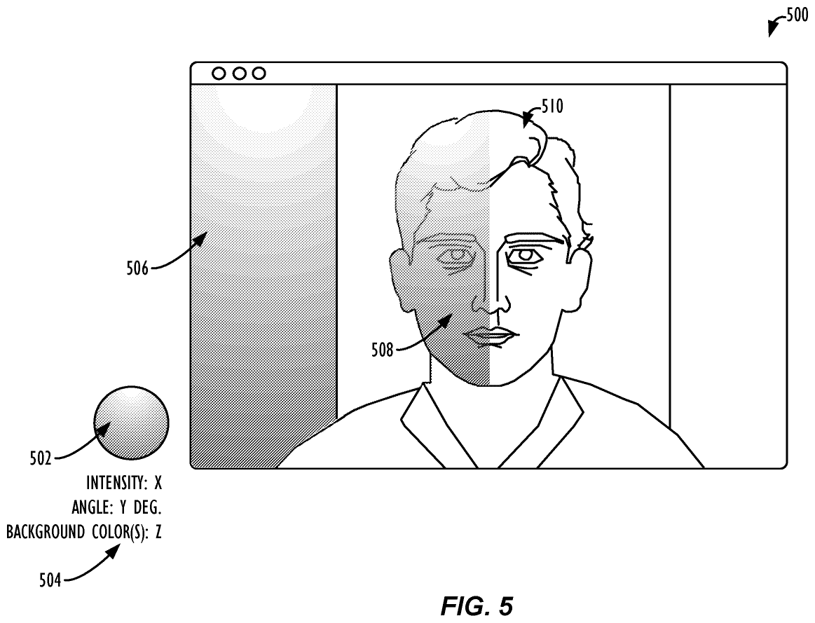

Turning now to FIG. 5, exemplary virtual lighting effects 500 that may be applied to augment live video streams are illustrated, according to one or more embodiments. Effective and/or interesting lighting of a presenter or participant in a videoconferencing session may be an important feature to add quality and enhance the content-sharing experience for both sending and receiving parties. However, it is not always possible for videoconferencing participants to employ sophisticated studio lighting set-ups during content sharing sessions, e.g., due to a lack of space, lack of time, lack of equipment, and/or lack of the necessary training/knowledge to light themselves (or their environment) in an effective and/or interesting manner.

Thus, it would be desirable, if lightweight and efficient techniques could be employed to add customizable and intelligent virtual lighting effects to live video image streams, in order to augment the video image streams and provide a higher-quality image to receiving parties. Ideally, such virtual lighting effects may be applied in a performant manner, leverage existing segmentation/person identification techniques, be informed by the latest in AI/ML-based models for lighting, and ultimately by composited and rendered into the augmented video images that are transmitted to a receiving party, such that the receiving party does not need to have any specialized software, features, or applications, in order to experience the augmented live video image stream that has had enhanced virtual lighting effects applied to it.

According to some embodiments, the virtual lighting effects may be applied only to the head area of an identified human subject (510) and/or to certain background surfaces (e.g., wall 506) in a live video image stream. This intentional limitation in the regions of the captured scene where the virtual lighting effects are applied may help to make the application of the virtual lighting effects more performant and/or avoid the application of the virtual lighting effects to areas of the captured scene wherein there is less confidence or knowledge in the depth and/or geometric structure of the surfaces and objects in the scene (e.g., backgrounds, walls, flat surfaces, dimly-lit regions of the scene, inanimate objects, etc.). Of course, if there was sufficient time, surface geometry confidence, and/or processing/thermal resources available to a sending electronic device, the virtual lighting effects described herein could also be applied to an entire captured video image frame.

According to some embodiments, the virtual lighting effects may utilize high quality, real-time maps of surface normals (e.g., as provided by one or more AI/ML-based or other image processing algorithms). Using such surface normal maps, for each relevant pixel in the video image (e.g., any pixel related to the head of a human subject detected in the image) it is possible to compute and determine the relationship of the object's surface at that pixel location with the virtual light source(s) that a user is attempting to augment the captured video image with. This allows the virtual lighting effects to dynamically track the movement of a user and/or changes in the scene over time-and thus appear more physically accurate than if, say, a static brightness filter were applied to all of the pixels in a particular portion of the captured video image.

Returning now to FIG. 5, and exemplary picker user interface (UI) tool 502 is illustrated, which may provide a user with an array (504) of customizable colors, intensities, angles, positions (e.g., specifying an x-, y- and/or z-position in the scene of the virtual lighting source), number of virtual lighting sources, etc., that they would like to use augment the lighting of the captured video images. For example, in FIG. 5, a user has chosen to apply a gradient lighting effect that appears to be coming from the left side of the image frame. Thus, only the left side 508 of human subject 510's face and a wall 506 on the left side of the image frame are visually affected by the selected virtual lighting effect. As may be understood the color, intensity, and/or angle of the virtual lighting effect may be changed or panned, with the resulting effects being applied to the augmented live video image stream in real-time and then transmitted to the receiving party. It is also to be understood that any suitable picker UI tool may be used, depending on how much customizability or freedom that it is desired to give to a user, e.g., in terms of the choice or number of virtual lighting effects to be applied, and picker UI tool 502 is merely one possible example.

### Exemplary Techniques for Performing Improved Audiovisual (AV) Synchronization in Augmented Live Video Streams

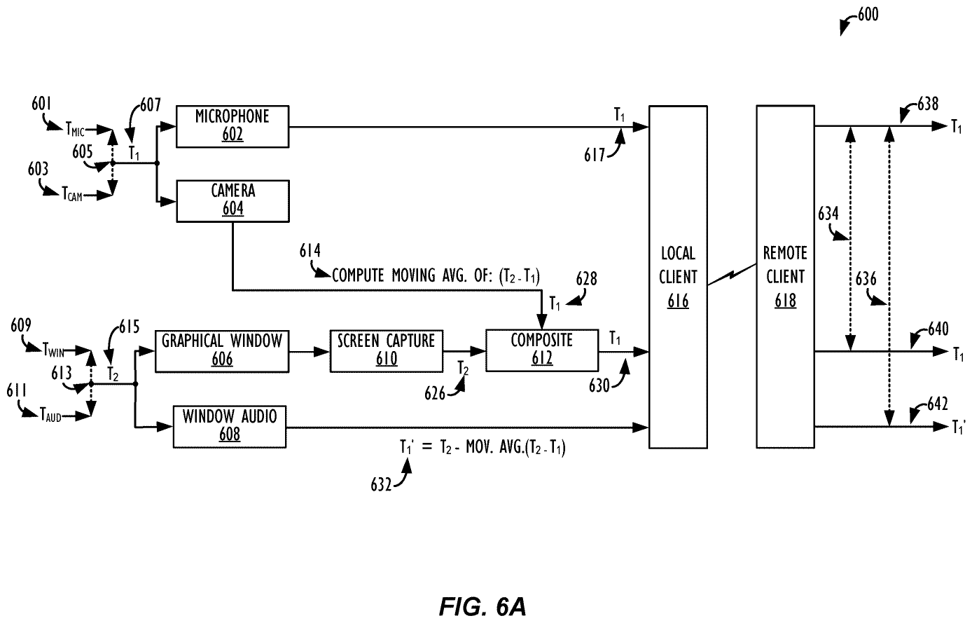

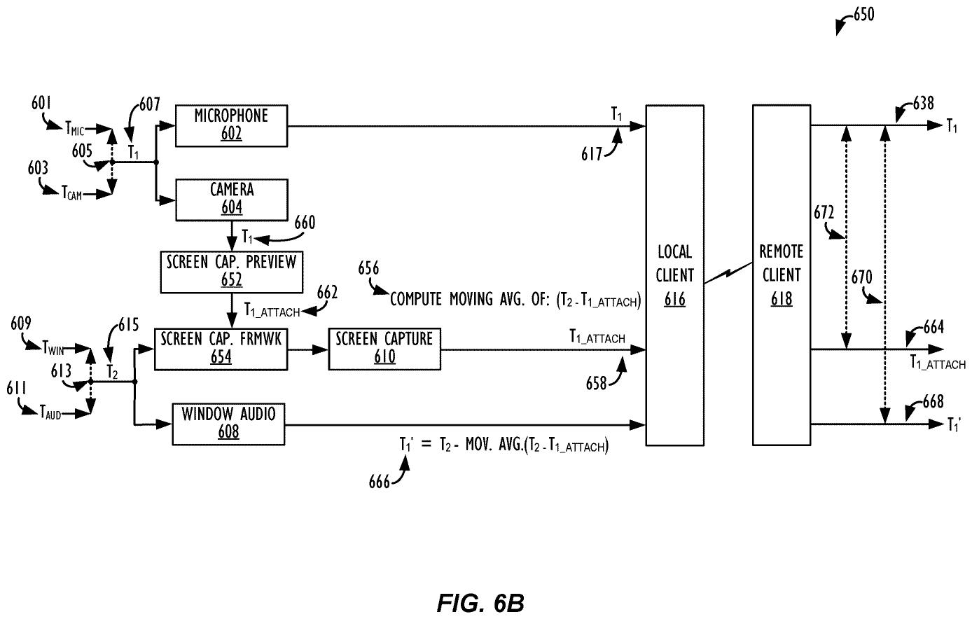

FIG. 6A illustrates an exemplary technique 600 for performing improved audiovisual AV synchronization in augmented live video streams, according to one or more embodiments. In a typical videoconferencing session, a Presenter may be streaming their microphone (602), camera (604), graphical window content (606), and/or graphical window audio stream (608) from a local client device (616), as illustrated in FIG. 6A. Thus, there are at least four AV content streams (i.e., T_{MIC} 601 for the microphone 602, T_{CAM} 603 for the camera 604, T_{WIN} 609 for the graphical window 606, and T_{AUD} 611 for the graphical window audio stream 608) that may need to be time synchronized before being received by videoconferencing participants (e.g., remote client device 618). The synchronization aspect is important for preventing “lip-syncing” issues between audio and video content for each pair of streams (i.e., AV content streams 601/603 related to the Presenter, and AV content streams 609/611 related to the Presenter's shared graphical content).

According to some implementations, AV content streams 601/603 (related to the Presenter) may first be synchronized (605) to a common timeline, which will be referred to herein as T1 (607) before being composited with other AV content streams, while AV content streams 609/611 (related to the Presenter's shared graphical content) may also first be synchronized (613) to a common timeline, which will be referred to herein as T2 (615) before being composited with other AV content streams.

The timeliness T1 and T2 could be different from each other for a variety of reasons. For example, a user may be using externally-connected camera (604) and/or microphone (602) sources, which may have significant delays, such that T2>T1. This difference in timing may not be important for most use cases, i.e., as long as the receiving parties are able to synchronize the camera 604 with the microphone 602 at time T1 (617), and also synchronize the graphical window content 606 with the graphical window audio stream 608 at time T2 before being transmitted to the remote client device 618.

However, in augmented live video image streams, wherein multiple sources of AV content may be composited together into the same augmented output video image, synchronization issues may arise. In particular, in cases where the visual effect involves streaming video images comprising a composite of a Presenter next to their screen sharing content (e.g., as described above with reference to Scenario 2C 200C in FIG. 2) the Presenter may be simultaneously streaming three AV content streams, i.e.: microphone 602; a camera/graphical window composite stream 612, and the graphical window audio stream 608, as shown in FIG. 6A.

The camera/graphical window composite stream 612 and the graphical window audio stream 608 must both be synchronized to the microphone 602 to prevent undesirable lip-syncing issues. In such cases, the receiving party cannot use the capture time T2 (615) for synchronization of the graphical window content 606 and the graphical window audio stream 608 with microphone 602, as T1 must drive the synchronization process to avoid lip-syncing issues. Likewise, simply appending T2 to the composite stream 612 would consume additional network bandwidth, which is not desirable. Further, the Real-Time Transport Protocol (RTP) standard payload does not allocate sufficient space for transmitting streams at both T1 and T2.

Thus, new techniques are described herein to ensure the graphical window content 606 in the composite stream 612 is synchronized correctly with the graphical window audio stream 608 for the receiving parties. In particular, graphical window content 606 may be captured by a screen capture application (610) of the local client device 616, i.e., still using the value of T2 (626), before being composited into the composite stream 612, which will be configured to use T1 (630).

According to some embodiments, a moving average (614) may be computed for the time difference between T2 and T1, while the original value of T1 (628) is still passed to the composite stream 612 for the camera 604. Next, the original window audio stream 608 time (i.e., at T2) may be replaced (632) with a value of T1′, wherein T1′ may be computed as: T2 minus the moving average difference computed at 614, as described above.

Finally, the receiving party (e.g., remote client device 618) may use the value of T1′ (shown as 642 at the remote client device 618) to synchronize the window audio stream 608 with the microphone stream (shown by the dashed line 636 connecting stream 638 and stream 642 at the remote client device 618). Similarly, the receiving party may use the value of T1 (shown as 640 at the remote client device 618) to synchronize the composite stream 612 with the microphone stream (shown by the dashed line 634 connecting stream 638 and stream 640 at the remote client device 618).

FIG. 6B illustrates another exemplary technique 650 for performing improved AV synchronization in augmented live video streams, according to one or more embodiments. (Note: element numerals in common between FIG. 6A and FIG. 6B refer to the same or analogous system components, and thus are not described again in detail for a second time with reference to FIG. 6B.)

In other types of augmented live video image streams, a visual effect may involve the streaming of video images comprising a composited screen capture of a moveable, smaller/cropped representation of the Presenter (e.g., just the Presenter's head) as captured by camera 604 next to (or on top of) their selected screen-sharing AV content (e.g., as described above with reference to Scenario 2B 200B in FIG. 2). Again, the Presenter in such a scenario may be simultaneously streaming at least three AV content streams, i.e.: microphone 602; a screen capture stream 610 (i.e., reflecting the smaller/cropped output from the camera 604 being composited together with a graphical window(s) of selected screen-sharing AV content), and the graphical window audio stream 608, as shown in FIG. 6B.

According to some embodiments, to achieve a more computationally-efficient design, the smaller/cropped representation of the Presenter may first be composited with the graphical window(s) of selected screen-sharing AV content, and then displayed on the Presenter's screen at local client device 616. Next, the entire screen (or a portion of the screen) may be captured by screen capture framework (654) and output as a screen capture stream 610, which includes the smaller/cropped representation of the Presenter along with selected screen-sharing AV content. Similar to the example illustrated in FIG. 6A, at least three ATV content streams are transmitted to the remote client device 618 in this configuration 650 illustrated in FIG. 6B.

In this configuration 650 illustrated in FIG. 6B, a new technique is introduced to prevent the loss of T1 information needed for synchronizing camera 604 with microphone 602 for receiving parties. First, the value of T1 (660) may be attached to a composited camera frame sent to a display rendering server of the local client device 616, which may then display the composited camera frame on the Presenter's screen (e.g., at screen capture preview block 652).

Next, the screen capture framework 6543 s render server may detect a value of T1_attach (662) that is received from the screen capture preview block 652 and attach this information to the screen capture frame that is captured by the screen capture framework 654 at time T2 (615) (i.e., the graphical content that the Presenter wishes to share). The screen capture framework 654 then replaces the screen frame time T2 (615) with the T1_attach (662) time and computes a moving average difference of T2 and T1_attach at 656, although the screen capture stream 610 may still be transmitted to the remote client device 618 using T1_attach (658). Additionally, the time T2 (615) for the graphical window audio stream 608 may be replaced with a value of T1′ (666), which may be computed as: T2 minus the moving average difference computed at 656.

Finally, the receiving party (e.g., remote client device 618) may use the value of T1′ (shown as 668 at the remote client device 618) to synchronize the window audio stream 608 with the microphone stream (shown by the dashed line 670 connecting stream 638 and stream 668 at the remote client device 618). Similarly, the receiving party may use the value of T1 attach (shown as 664 at the remote client device 618) to synchronize the screen capture stream 610 with the microphone stream (shown by the dashed line 672 connecting stream 638 and stream 664 at the remote client device 618).

As may now be appreciated, the techniques illustrated in FIG. 6B thus provide receiving parties with the required information for synchronizing the sending device's microphone stream, screen capture stream, and window audio stream.

### Exemplary Methods of Augmenting Live Video Image Streams With Depth-Aware Visual Effects

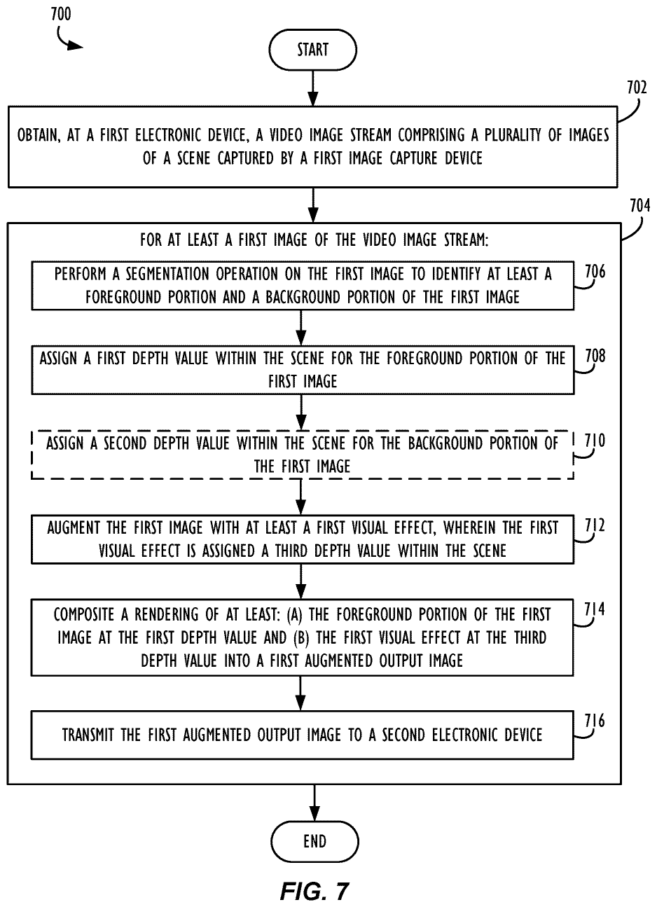

FIG. 7 is a flow chart, illustrating a method 700 of augmenting a live video image stream with depth-aware visual effects, according to various embodiments. First, at Step 702, the method 700 may obtain, at a first electronic device, a video image stream comprising a plurality of images of a scene captured by a first image capture device. Next, the method 700 may initiate a for-loop 704, via which Steps 706-716 may be iteratively performed for each of one or more images of the video image stream. Steps 706-716 will be described herein in the context of being performed on a “first image” of the video image stream, although it is to be understood that one or more of Steps 706-716 may be similarly performed for any number of the images in the video image stream to which it is desired to apply depth-aware visual effects.

Turning now to Step 706, for at least a first image of the video image stream, the method 700 may perform a segmentation operation on the first image to identify at least a foreground portion and a background portion of the first image. As described above, in some embodiments, the segmentation operation may be enabled by one or more Artificial Intelligence (AI) or Machine Learning (ML)-based algorithms, e.g., AI/ML-based algorithms trained to identify and segment out foreground human subjects (and/or common handheld objects or other accessories that may be held by or otherwise connected to said foreground human subject) in captured images. Preferably, such segmentation operations are performant (e.g., from both processing and thermal standpoints) and are able to deliver accurate segmentation masks for captured images in real-time, i.e., as captured video images are being streamed from an image capture device.

Next, at Step 708, the method 700 may assign a first depth value within the scene for the foreground portion of the first image. As described above, in some embodiments, the first depth value assigned to a foreground portion of the first image may be an actual estimated depth of the human subject (or other object(s)) making up a majority of the determined foreground portion of the first image. For example, a first depth value may be estimated via stereo imagery, disparity calculations, Time of Flight (ToF) cameras, phase detection pixels, AI/ML-based monocular depth estimation frameworks, or whatever other depth estimation modality may be preferred or available in a given implementation. In other embodiments, the first depth value assigned to the foreground portion of the first image may be a depth that is different than an estimated actual depth of a human subject in the foreground portion of the first image. For example, in the augmented output image, the foreground portion of the captured first image could be altered to appear to have a nearer (or farther) depth in the first image, or the foreground portion may be cropped and composited at the same apparent depth (or a different depth) than other visual content that may be being composited with the foreground portion, e.g., before being transmitted to a second electronic device.

Next, at Step 710, the method 700 may optionally assign a second depth value within the scene for the background portion of the first image. As described above, the background portion of the first image may be estimated using a segmentation operation (e.g., in some embodiments, any portions of the first image not designated as foreground portions may be designated as background portions). In some embodiments, an actual estimated depth of background portion of the first image may be determined via any preferred depth estimation modality. In other embodiments, some other value may simply be assigned to serve as the second depth value for the background portion of the first image. In still other embodiments, no value (or a default value) may be used to serve as the second depth value for the background portion of the first image. As described above, some visual effects may require a scene background depth, so that the depth-aware visual effects may be rendered at a correct apparent depth in the scene relative to the foreground portion of the scene and/or have appropriate/semantically-correct interactions with the assigned scene background. In some implementations, an estimated second depth value for the scene background may also help the segmentation operation by allowing it to tighten (or loosen) its constraints when identifying which portions of the captured image are likely to be part of the foreground.

Next, at Step 712, the method 700 may augment the first image with at least a first visual effect, wherein the first visual effect is assigned a third depth value within the scene. As described above, e.g., with reference to FIGS. 2, 3, and 5, many different types of depth-aware visual effects are possible to augment live video image streams, and those described herein are but several examples. As described above, by assigning each visual effect its own depth value(s) within the scene, more realistic composited renderings may be made, e.g., involving interactions and/or contextual-awareness between the visual effects and objects (e.g., human subjects) detected in the foreground portion of the captured images.

Next, at Step 714, the method 700 may composite a rendering of at least: (a) the foreground portion of the first image at the first depth value and (b) the first visual effect at the third depth value into a first augmented output image. In some embodiments, all or a portion of the background portion of the first image may also be included in the first augmented output image, e.g., at the second depth value, if one was assigned at Step 710. By compositing at least the two layers of the foreground portion and the visual effect together into the augmented output image (which augmented output image may be combined with other such augmented output images over time into an augmented video image stream), e.g., before being transmitted to a second electronic device, such second electronic device would not need any specialized software or awareness of the protocol or format of the visual effects in order to render them correctly at the second electronic device. Instead, the visual effects would already be “baked into” the video which may be encoded and/or transmitted according to any standardized or desired video encoding format.

Finally, at Step 716, the method 700 may transmit the first augmented output image to a second electronic device. As described above, this transmission may be performed as part of a video image stream that is being transmitted to the second electronic device, according to any standardized or desired video transmission protocol, e.g., as part of a videoconferencing application, screen sharing application, or the like.

As may be appreciated, the various methods described herein, e.g., with reference to FIG. 7, may be performed by an electronic device, e.g., via being initiated by an application (or “App”) executing on the device and/or the device's native operating system (OS). For example, an App executing on the device could initiate or implement all of the steps in a method, or at least a portion of the steps in the method, while making calls to the device's OS to perform other steps in the method. Similarly, a device's OS can receive API calls from an App or elsewhere and process/perform the calls to cause the method to be performed by the device(s).

### Exemplary Electronic Computing Devices

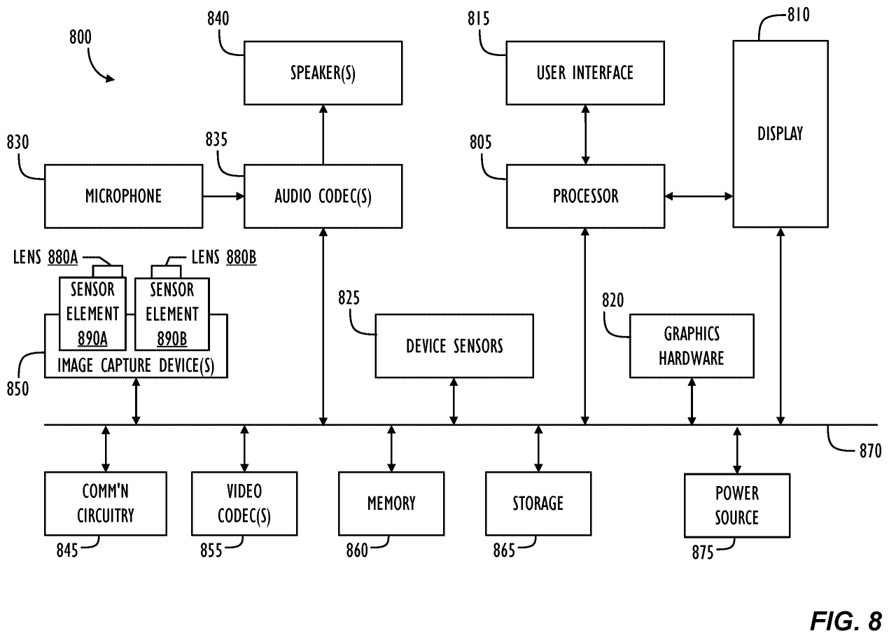

Referring now to FIG. 8, a simplified functional block diagram of illustrative programmable electronic computing device 800 is shown according to one embodiment. Electronic device 800 could be, for example, a mobile telephone, personal media device, portable camera, or a tablet, notebook or desktop computer system. As shown, electronic device 800 may include processor 805, display 810, user interface 815, graphics hardware 820, device sensors 825 (e.g., proximity sensor/ambient light sensor, accelerometer, inertial measurement unit, and/or gyroscope), microphone 830, audio codec(s) 835, speaker(s) 840, communications circuitry 845, image capture device 850, which may, e.g., comprise multiple camera units/optical image sensors having different characteristics or abilities (e.g., Still Image Stabilization (SIS), HDR, OIS systems, optical zoom, digital zoom, etc.), video codec(s) 855, memory 860, storage 865, and communications bus 870.

Processor 805 may execute instructions necessary to carry out or control the operation of many functions performed by electronic device 800 (e.g., such as the generation, processing, and/or streaming of images and video data in accordance with the various embodiments described herein). Processor 805 may, for instance, drive display 810 and receive user input from user interface 815. User interface 815 can take a variety of forms, such as a button, keypad, dial, a click wheel, keyboard, display screen and/or a touch screen. User interface 815 could, for example, be the conduit through which a user may view a captured video stream and/or indicate particular image frame(s) that the user would like to capture (e.g., by clicking on a physical or virtual button at the moment the desired image frame is being displayed on the device's display screen). In one embodiment, display 810 may display a video stream as it is captured while processor 805 and/or graphics hardware 820 and/or image capture circuitry contemporaneously generate and store the video stream in memory 860 and/or storage 865. Processor 805 may be a system-on-chip (SOC) such as those found in mobile devices and include one or more dedicated graphics processing units (GPUs). Processor 805 may be based on reduced instruction-set computer (RISC) or complex instruction-set computer (CISC) architectures or any other suitable architecture and may include one or more processing cores. Graphics hardware 820 may be special purpose computational hardware for processing graphics and/or assisting processor 805 perform computational tasks. In one embodiment, graphics hardware 820 may include one or more programmable graphics processing units (GPUs) and/or one or more specialized SOCs, e.g., an SOC specially designed to implement neural network and machine learning operations (e.g., convolutions) in a more energy-efficient manner than either the main device central processing unit (CPU) or a typical GPU, such as Apple's Neural Engine processing cores.

Image capture device 850 may comprise one or more camera units configured to capture images, e.g., images which may be processed to generate cropped, augmented, and/or distortion-corrected versions of said captured images, e.g., in accordance with this disclosure. Image capture device(s) 850 may include two (or more) lens assemblies 880A and 880B, where each lens assembly may have a separate focal length. For example, lens assembly 880A may have a shorter focal length relative to the focal length of lens assembly 880B. Each lens assembly may have a separate associated sensor element, e.g., sensor elements 890A/890B. Alternatively, two or more lens assemblies may share a common sensor element. Image capture device(s) 850 may capture still and/or video images. Output from image capture device 850 may be processed, at least in part, by video codec(s) 855 and/or processor 805 and/or graphics hardware 820, and/or a dedicated image processing unit or image signal processor incorporated within image capture device 850. Images so captured may be stored in memory 860 and/or storage 865.

Memory 860 may include one or more different types of media used by processor 805, graphics hardware 820, and image capture device 850 to perform device functions. For example, memory 860 may include memory cache, read-only memory (ROM), and/or random access memory (RAM). Storage 865 may store media (e.g., audio, image and video files), computer program instructions or software, preference information, device profile information, and any other suitable data. Storage 865 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 860 and storage 865 may be used to retain computer program instructions or code organized into one or more modules and written in any desired computer programming language. When executed by, for example, processor 805, such computer program code may implement one or more of the methods or processes described herein. Power source 875 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 800.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

1. A method, comprising:
obtaining, at a first electronic device, a video image stream comprising a plurality of images of a scene captured by a first image capture device; and for at least a first image of the video image stream:
performing a segmentation operation on the first image to identify at least a foreground portion and a background portion of the first image;
assigning a first depth value within the scene for the foreground portion of the first image;
assigning a second depth value within the scene for the background portion of the first image;
augmenting the first image with at least a first visual effect, wherein the first visual effect is assigned a third depth value within the scene;
compositing a rendering of at least: (a) the foreground portion of the first image at the first depth value and (b) the first visual effect at the third depth value into a first augmented output image; and
transmitting the first augmented output image to a second electronic device.

2. The method of claim 1, wherein the first image of the video image stream was visually enhanced in at least one of the following ways before being obtained at the first electronic device: being cropped according to one or more predetermined framing rules, having distortion corrected applied, or having tone mapping applied.

3. The method of claim 1, wherein the first image capture device is connected to first electronic device in one of the following ways: a wired connection, a wireless connection, or via being embedded in first electronic device.

4. The method of claim 1, wherein the first augmented output image is transmitted to the second electronic device as part of a videoconferencing application.

5. The method of claim 1, wherein the foreground portion of the first image comprises at least one human subject.

6. The method of claim 1, wherein the first depth value is assigned based on an estimated depth within the scene of the foreground portion of the first image.

7. The method of claim 1, wherein third depth value is at least one of:
(1) less than the first depth value;
(2) greater than the first depth value;
(3) between the first depth value and the second depth value; or
(4) equal to the first depth value.

8. The method of claim 1, wherein the first visual effect comprises at least one of:
(1) a virtual lighting effect;
(2) a graphical window containing visual content; or
(3) a graphical representation of a reaction of a human subject captured in the scene.

9. The method of claim 1, wherein the first visual effect comprises a graphical window containing visual content, and wherein the third depth value is greater than the first depth value.

10. The method of claim 5, wherein the first visual effect comprises a graphical window containing visual content, and wherein the foreground portion is cropped based on a size and location of a detected face of the human subject prior to rendering.

11. The method of claim 5, wherein the first visual effect comprises a graphical representation of a reaction of the human subject, and wherein at least one of: (1) the third depth value; or (2) a placement of the graphical representation of the reaction of the human subject is based, at least in part, on a size or location of the human subject.

12. The method of claim 5, wherein the first visual effect comprises a graphical representation of a reaction of the human subject, and wherein the graphical representation comprises an emoji or an image.

13. The method of claim 1, wherein the first visual effect comprises a graphical window containing visual content, and wherein the visual content of the graphical window is selected via an application programming interface (API) or operating system (OS)-level feature of the first electronic device.

14. The method of claim 4, wherein the first visual effect comprises a graphical window containing visual content, and wherein the visual content is rendered into a first augmented output image, at least in part, at a second resolution that is independent of a first resolution at which the visual content is being displayed at the first electronic device.

15. The method of claim 5, wherein the first visual effect comprises a virtual lighting effect, wherein the virtual lighting effect comprises at least one of: (1) a virtual light color; (2) a virtual light intensity; or (3) a virtual light placement, and wherein augmenting the first image with the virtual lighting effect further comprises estimating a set of surface normals for the human subject in the first image.

16. The method of claim 1, further comprising:
augmenting the first image with at least a second visual effect, wherein the second visual effect is assigned a fourth depth value within the scene,
wherein the compositing further comprises compositing a rendering of: (c) the second visual effect at the fourth depth value into the first augmented output image, and
wherein the third depth value and fourth depth value are different.

17. The method of claim 1, wherein the first visual effect comprises a graphical window containing first audiovisual (AV) content, wherein the video image stream comprises second AV content, and wherein a timing of an audio component of the first AV content is adjusted based, at least in part, on a timing of an audio component of the second AV content before being transmitted to the second electronic device.

18. The method of claim 17, wherein the timing of the audio component of the first AV content is further adjusted based, at least in part, on a moving average difference between: (1) the timing of the audio component of the first AV content; and (2) the timing of the audio component of the second AV content.

19. An electronic device, comprising:
a memory; and
one or more processors operatively coupled to the memory, wherein the one or more processors are configured to execute instructions causing the one or more processors to:
obtain, at the electronic device, a video image stream comprising a plurality of images of a scene captured by a first image capture device; and
for at least a first image of the video image stream:
perform a segmentation operation on the first image to identify at least a foreground portion and a background portion of the first image;
assign a first depth value within the scene for the foreground portion of the first image;
assign a second depth value within the scene for the background portion of the first image;
augment the first image with at least a first visual effect, wherein the first visual effect is assigned a third depth value within the scene;
composite a rendering of at least: (a) the foreground portion of the first image at the first depth value and (b) the first visual effect at the third depth value into a first augmented output image; and
transmit the first augmented output image to a second electronic device.

20. A non-transitory computer readable medium (CRM) comprising computer readable instructions executable by one or more processors of an electronic device to:
obtain, at the electronic device, a video image stream comprising a plurality of images of a scene captured by a first image capture device; and
for at least a first image of the video image stream:
perform a segmentation operation on the first image to identify at least a foreground portion and a background portion of the first image;
assign a first depth value within the scene for the foreground portion of the first image;
assign a second depth value within the scene for the background portion of the first image;
augment the first image with at least a first visual effect, wherein the first visual effect is assigned a third depth value within the scene;
composite a rendering of at least: (a) the foreground portion of the first image at the first depth value and (b) the first visual effect at the third depth value into a first augmented output image; and
transmit the first augmented output image to a second electronic device.
